(19) United States
(12) Patent Application Publication
(10) Pub. No.: US 2012/0251756 A1
(43) Pub. Date: Oct. 4, 2012

(54) ADHESIVE BACK ANTIMICROBIAL COVER FOR USE ON HIGH VOLUME TOUCH SURFACES

(76) Inventor: Brian Buckley, Agoura Hills, CA (US)

(21) Appl. No.: 13/436,979

(22) Filed: Apr. 1, 2012

Related U.S. Application Data
(60) Provisional application No. 61/516,288, filed on Apr. 1, 2011.

(51) Int. Cl. B32B 7/12; B65D 33/24; B05D 3/12

(52) U.S. Cl. 428/41.8; 427/289; 383/84

(57) ABSTRACT

A cover member is provided for attachment to a contacted surface having a predetermined size and shape. The contacted surface is a surface that is regularly subjected to physical contact. The cover member includes a sheet-like substrate having a first and second surfaces, and an area that is sized and shaped to coincide with the predetermined size and shape of the contacted surface. An adhesive layer is disposed on the second surface of the substrate. A releasable backing member is attached to the adhesive layer, and an antimicrobial coating is disposed on the first surface of the substrate.

### PRIORITY STATEMENT

The instant application claims benefit to Brian Buckley, U.S. Provisional Patent Applications Nos. 61/464,414 filed on 4 Mar. 2011 and 61/516,288 filed 1 Apr. 2011, both of which are entitled “Adhesive Back Antimicrobial Label for Use on High Volume Touch Surfaces” and which both are fully incorporated herein by reference.

### TECHNICAL FIELD OF THE INVENTION

The present invention relates to products for covering surfaces, and more particularly, to an adhesive backed cover device that include an antimicrobial surface. The cover of the present invention has special utility on high touch surfaces that are touched by a large number of people, such as elevator buttons and touch screens.

### BACKGROUND OF THE INVENTION

With the long term use of antibiotics, there have evolved a large number of strains of antibiotic resistant virulent microbes. The microbes cause such diseases as MRSA, that, if left untreated, can lead to severe sickness and/or death.

The existence of these virulent and often antibiotic resistant microbial strains, along with the enhanced awareness of the role played by such microbes in causing illness and death have caused the consuming public to become acutely “germ conscious”. This “germ consciousness” has led to a strong demand for various products that promote good health and hygiene, by having the capability of killing germs to thereby reduce or eliminate the spread of germs. For example, antimicrobial compositions have been placed into products as diverse as fabrics, sutures, and animal products, such as pet cages and bird feeders. Additionally, hand sanitizer dispensers have become ubiquitous in homes, offices and commercial settings.

Several different types of antimicrobial agents exist that can be applied to surfaces of items for which antimicrobial protection is sought. One class of antimicrobial compounds comprises chemical antimicrobial compounds, such as common disinfectants and the like. Although chemical antimicrobial agents have been used for years with generally good results, certain problems exist. In particular, many chemical antimicrobial agents are not necessarily friendly to the environment, and can cause bio-accumulation in organisms that encounter the chemicals; or possibly poisoning.

Other chemical antimicrobial agents have the problem of losing their antimicrobial activity within a short period of time. This period of anti-microbial activity is often substantially less than the useful life of the product on which they are applied.

Another issue with some chemical antimicrobial agents is that they may have some inherent toxicity, so that along with killing the microbes that they are intended to kill, many kill other encountered organisms, or otherwise lead to long term health problems for the encountered human or other animal population.

Other commonly used antimicrobial agents include metal-based antimicrobial agents. In particular, it has been found that silver and copper have significant antimicrobial activities. In this regard, a New Jersey company, known as Argent 47, has developed an antimicrobial fabric material that uses silver as its antimicrobial agent. This silver-containing antimicrobial agent has sufficient antimicrobial activity to allegedly be capable of reducing the spread of germs. Because of its antimicrobial activity, this silver-containing fabric has found usage in healthcare settings where there exists both an abnormally high amount of virulent microbial agents, and also where reduction or elimination of such virulent microbial agents is highly desirable due to the sickness and vulnerability of the patients residing in the healthcare facility.

Additionally, silver-containing antimicrobial agents are produced by a company known as Agion. Agion incorporates silver within a carrier material, so as to give the antimicrobial agent a carrier to which the agent can attach and stay resident on for a long period of time. Among the patents owned by Agion are U.S. Pat. No. 7,585920, 7,598,300, 6,296,863, 6,582,715, 7,645,824, 7,357,949, 7,595,355, 6,248,342, 6,585,767, 6,267,590, 6,436,422, 6,365,130 and 6,866,859.

Although silver and copper based antimicrobial agents are capable of performing the antimicrobial function in a workmanlike manner, they also have certain drawbacks. As such, room for improvement exists. In particular, many silver-based antimicrobial agents have the disadvantage of being very expensive, or at least expensive enough so that the additional cost that they impart to products normally considered to be “cheap and disposable” is great enough so that people would tend to avoid the purchase of such silver antimicrobial agent-containing products, because the antimicrobial benefit obtained is not perceived to be worth the additional cost. Therefore, such metal-containing antimicrobial agents are not necessarily economically viable in certain low-cost products.

There exists a class of generally low-cost goods, on which silver would likely not be a satisfactory antimicrobial agent due to its expense, but for which an antimicrobial agent would be very valuable. This class of goods includes those everyday objects that are found in homes, work places and commercial areas, that are touched often by persons, and especially those objects that are touched often by a wide variety of different persons.

These objects include such “high touch” items as touch screens that may exist at commercial establishments such as restaurants on which orders are entered and bills are tallied; touch screens in public areas such as touch screen kiosks at airport check-in areas; and other various touch screens used throughout commercial and industrial settings. Other examples of touch screens used in public include such things as ATM machines and various input devices used on industrial equipment in plants.

Such touch screens are ubiquitous. Although some touch screens, such as touch screens on phones are generally touched many times by a small number of different people, many of these public area touch screens are touched by a large number of different people.

In addition to touch screens, there are many other “high touch” surfaces that are physically contacted by a large number of different people. Such surfaces include elevator buttons, telephone screens, key pads on locks and terminals such as ATMs and gas pumps, handicapped door activator plates, door knobs, electric dryer on-buttons, telephone key pads, cash register input pads, metal plates or crash bars of the type that one might find on a commercial exit door.

One way to potentially impart some antimicrobial activity to these surfaces would be to incorporate antimicrobial activity onto the surface itself. However, one problem with doing so is that antimicrobial surface agents may not be useable on all products. Additionally, in order to place an antimicrobial surface coating on such surfaces, one would need to spend a significant amount of funds to retrofit many existing high touch surfaces. Further, one might also have difficulty finding a surface coated antimicrobial agent that was capable of remaining antimicrobially active over the several year life span of many of the goods discussed above.

Therefore, one way to impart an antimicrobial surface to a particular product, without the need to retrofit is by the use of a cover that can be adhesively attached to and subsequently removed from the “high touch” surface.

Therefore, one object of the present invention is to provide a cover device that can be applied to a high touch surface, and that includes an antimicrobial agent, to inhibit the growth of and reduce the spread of microbes. In a most preferred embodiment, this cover can comprise a label-like cover.

### SUMMARY OF THE INVENTION

In accordance with the present invention, a cover member is provided for attachment to a contacted surface having a predetermined size and shape. The contacted surface is a surface that is regularly subjected to physical contact. The cover member comprises a sheet-like substrate having a first and second surfaces, and an area that is sized and shaped to coincide with the predetermined size and shape of the contacted surface. An adhesive layer is disposed on the second surface of the substrate. A releasable backing member is attached to the adhesive layer, and an antimicrobial coating is disposed on the first surface of the substrate.

Preferably, the antimicrobial coating comprises a bacteriostatic antimicrobial coating that functions by piercing the cell walls of microbes; and the substrate comprises a transparent plastic sheet. Additionally, the cover member should include a substrate that has a tear resistance, and an adhesive that has a detachment strength that is matched with respect to each other so as to form either one of a peelable cover member, and more preferably, an ultrapeelable cover member.

The detachment strength relates to the amount of force generally necessary to separate the cover member from the surface on to which it is attached, such as the surface of a touch screen.

One feature of the present invention is that a micro-biostatic antimicrobial coating is employed to impart antimicrobial properties to the cover member. One advantage of the use of a micro-biostatic antimicroial coating is that environmentally friendly micro-biostatic coatings exist. Micro-biostatic antimicrobial coatings generally do not have chemical toxicity issues, either for plants or organisms. As such, the use of a micro-biostatic antimicrobial coating and the ultimate placement of such a coating containing product in a landfill is not likely to result in long term adverse environmental impacts, that are significantly greater than the environmental impacts that result from the substrate on which the coatings are placed.

Another feature of micro-biostatic antimicrobial coatings is that they generally have a long useful life thereby providing a desirably long interval between the need for replacement of a cover with a “fresh” cover. In this regard, it is believed that the useful life of many of the covers created according to the present invention, during which they will exhibit antimicrobial activity, will generally be in the ninety day range. Although the coatings may maintain antimicrobial activity long past that time, it is believed generally by the Applicant, that after the anticipated ninety day time period, the cover and substrate itself will tend to degrade in both appearance and adhesive characteristics, to make it desirable to change the cover regardless of the useful life of the micro-biostatic antimicrobial coating.

A further feature of the present invention is that the antimicrobial coating can be applied by traditional printing and coating processes. This feature has the advantage of obviating the need for the manufacturer to invest monies to purchase or create specialized capital equipment, in order to produce covers containing the antimicrobial coatings. Rather, the coatings should be able to be applied by any printer using a flexographic printing process, and associated equipment of the type already in use by the printer to print conventional label/cover products.

Those in the printing industry are well familiar with flexographic printing processes, as such processes are the primary printing processes used in connection with labels. Typically, a flexographic printing process comprises a web of paper that is pulled through one or more roller sets, depending upon the number of colors to be applied to the item to be printed. A flexible printing plate is attached to one of the rollers to apply the ink to the label being printed. Ink is applied to the plate that is then applied to the web of paper, as the paper is pulled through the roller containing the plate.

The micro-biostatic antimicrobial coating of the present invention is preferably applied during the printing process, with the conventional printing equipment, such that the application of the antimicrobial coating is not unlike the application of an ink and may be applied at a station that could otherwise be used for depositing an ink color or a coating such as varnish coating.

These and other features of the present invention will become apparent to those skilled in the art upon a review of the drawings and detailed description presented below that represent the best mode of practicing the invention perceived presently by the Applicant.

### IN THE DRAWINGS

FIG. 1 is a perspective view of a cover member of the present invention;

FIG. 1A is a side, largely schematic view of the cover products of the present invention;

FIG. 1B is an exploded view of the cover product with base;

FIG. 2 is a top, somewhat schematic view of the cover of the present invention as applied to a panel of elevator buttons;

FIG. 3 is a side, sectional view taken along lines 3-3 of FIG. 2, of a cover applied to an elevator button;

FIG. 4 is a plan view of the cover of the present invention as applied to a touch screen monitor;

FIG. 5 is a sectional view taken along lines 5-5 of FIG. 4;

FIG. 6 is a plan view of a mobile communication device, such as a Smart Phone showing the cover of the instant invention applied to the touch screen thereof;

FIG. 7 is a plan view of an actuator plate for a door used as a handicap entrance, showing the present invention applied thereto;

FIG. 8 is a sectional view taken along lines 8-8 of FIG. 7;

FIG. 9 is a schematic view of a cover making machine used in connection with a cover of the present invention;

FIG. 10 is a perspective view of an antimicrobial cover that is provided in a tape format, and is capable of serving as an adhesive tape;

FIG. 11 is a greatly enlarged sectional view taken along lines 11-11 of FIG. 10;

FIG. 12 is a top plan view of a pouch-like remote control cover present invention; and

FIG. 13 is a sectional view taken along lines 13-13 of FIG. 12.

### DETAILED DESCRIPTION

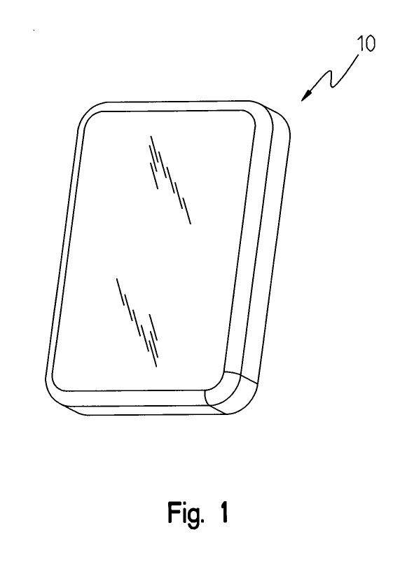

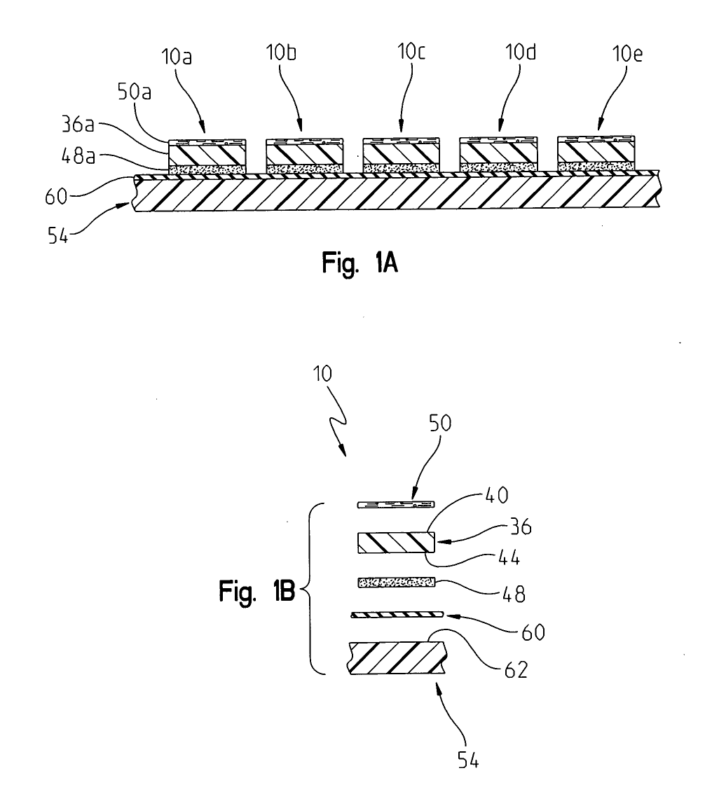

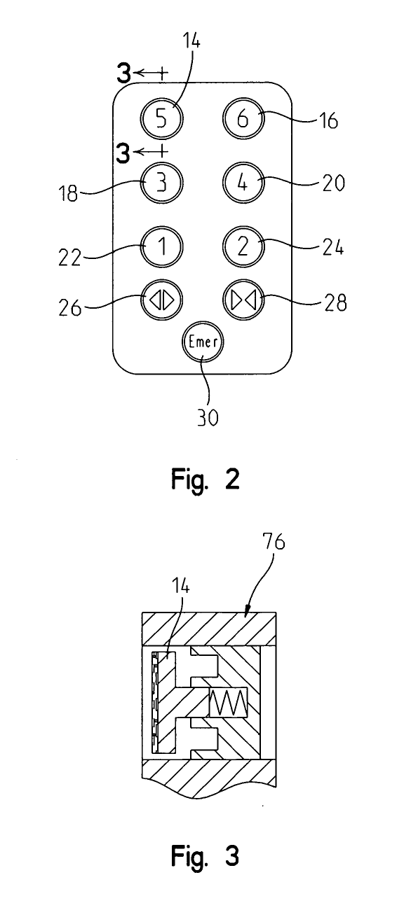

The cover member of the present invention is shown in FIGS. 1, 1A, 1B and 2. As shown in FIG. 2, the cover member 10 generally comprises a transparent sheet of plastic-like material that is sized and shaped to cover all or a portion of a surface regularly subjected to physical contact from humans, such as a touch screen. The cover member material is chosen to be transparent, so that any writing or display that is contained on the contacted surface of an item such as a “high touch” item is visible through the cover so that it can be read by the user.

As used in this application, the term “high touch” item is used to include a wide variety of devices and items that one would wish to cover with an antimicrobial cover. The designation of a device as a high touch device is based on such factors as the number of times that the device is touched, the number of different people touching the device, and the environment in which the device operates. For example, a touch screen display on a restaurant cash register or order in-put device might not be the type of product that is touched by a large number of people, but rather, is only touched by a few to a few dozen restaurant workers who use it. Nonetheless, due to hygiene concerns within a food establishment, along with the presence of germs caused by the large number of customers and food products, one might desire an antimicrobial touch screen over such a high touch item.

Viewed another way, the need and/or desire for a device such as the present invention increases based on factors such as (1) the number of different people who typically touch an item; (2) the number of times that an item is touched during a given time period; (3) cleanliness standards imposed on the environment in which the covered item is used; and (4) quantity of potentially harmfully microbes that are typically present in the environment in which the covered device is used.

As another example, an elevator floor button 14 (FIG. 2) is also a high touch item. Although elevator buttons 14, 16, 18, 20, 22, 24, 26, 28, 30 do not necessarily exist in particularly germ-prone environments, the large number of different people who touch an elevator touch button present a large possibility for the proliferation and transfer of germs, thereby increasing the likelihood that germs will be resident on the buttons due to the large number of persons touching the elevator buttons.

Another category of high touch areas includes any of a myriad of surfaces that children contact at a pre-school, day care or other school environment. For example, a classroom touch screen on a classroom computer would likely be touched by a large number of different people, as most of the students in the classroom would probably touch the screen at one time or another on any given day. Additionally, as children tend to be careless about maintaining good hygiene practices, there exists a possibility of cross infection among the children, caused by germs resident on the touch screen being passed among the students.

Turning back to FIGS. 1 and 2, the cover 10 includes a sheet like plastic or paper base (also known as a substrate) 36 that is preferably transparent and made from a tear resistant plastic film. Substrate 36 includes an upper surface 40 and a lower surface 44. The lower surface 44 is the surface that is generally applied to the high touch surface. Preferably, the lower surface 44 includes some sort of adhesive member or coating so that it will remain coupled to the high touch surface.

A large number of useable adhesives exist. Preferably, the adhesive strength of the adhesive used and the tear strength of the substrate 36 are matched so as to enable the adhesive to bond strongly enough to the high-touch surface to enable the cover to remain in position on the high touch surface. Nonetheless, the adhesive should be weak enough and the substrate 36 be sufficiently tear resistant to permit the user to easily remove the cover 10 from the surface in one piece, without forcing the user “scratch off” the old cover 10 in a manner similar to the one in which would need to scratch a label off a beer bottle or a ketchup bottle.

One would not wish to use too strong of an adhesive (e.g. a non-removable or permanent strength adhesive) because a high strength adhesive would have too great of a detachment strength, and thereby it would be difficult to remove the cover, thus causing the cover member to be almost permanently adhered to the high touch surface or requiring the user to resort to scratching off the cover from the device. On the other hand, one needs a strong enough adhesive, so that the cover member has a great enough detachment strength so that the cover does not become dislodged easily from the surface to which it is applied. In this regard, choosing an adhesive that has the appropriate strength is something of a balancing act, much like the balancing act faced by the creator of Scotch Post-it Notes®.

Preferably, the adhesive chosen should comprise an adhesive that, in combination with the substrate 36, will produce a peelable or more preferably, an ultra peelable label. A peelable label is defined as one where adhesive is fairly strong, and that will not fall off in normal circumstances, although the label can be removed relatively easily without tearing the substrate or leaving adhesive behind on the old surface. This type of label is classified as a removable label.

An ultra-peelable label is designed primarily for use on book covers and glass. When removed, these labels usually leave no residue whatsoever. Adhesion of the label is weak but is still suitable for light duty applications. Ultra peelable labels are also classified as removable labels.

Examples of adhesives that will perform well with the instant application are those adhesives found on labels that can be purchased from a large number of label stock manufacturers who produce the base stock for the production of labels. Such label stock providers include companies such as Fasson, Flexcon, and 3M.

The upper surface 40 of the label includes the antimicrobial coating 50. As alluded to above, the antimicrobial coating 50 that is applied to the upper surface 40 should be a microbiostatic antimicrobial coating 50. Several suppliers exist that provide such microbiostatic antimicrobial coating. These suppliers include such companies as AM500, Triton Technology Group and Coating Specialists' Groups.

AM500 describes a micro-biostatic antimicrobial coating that they produce as follows at www.AM500.com.

The [AM500] Microbiostatic Antimicrobial Coating, prevents the growth of an amazingly large array of bacteria, mold, mildew, algae, and yeast. The Microbiostatic Antimicrobial Coating acts like a bed of microscopic spikes that pierce the cell walls of microbes . . .

One end of the coating's molecule creates a strong bond with a multitude of surfaces, porous and non-porous, forming a highly durable protective coating. The other end of the molecule forms a microscopic bed of spikes that punctures microbes like a bed of nails. Microbiostatic Antimicrobial Coatings physically rupture the cell walls of these microbes, without the use of poisons. Since Microbiostatic Antimicrobial Coating's methodology is mechanical instead of a poison, it does not create “superbugs,” which are microbes that build up a resistance to treatment.

The Microbiostatic Antimicrobial Coating's molecular spikes are long chains of atoms that are large enough to pierce the cell walls of various microbes. Being only about one thousandth the diameter of a human hair, they are too small to harm large cells in mammals. These chains of atoms carry a strong positive charge that attracts negatively charged bacteria. Microbiostatic Antimicrobial Coatings when blended with a neutral disinfectant cleaner have been found in independent testing to be effective against a wide array of microbes, including H1N1 (Swine Flu), MRSA, Staphylococcus aureus, E. coli, various Salmonella strains, black mold, athlete's foot, Influenza A, skin infections, and others . . .

Over 30 years of research and development went in to the creation of the Microbiostatic Antimicrobial Coating. The technology has undergone extensive independent laboratory testing and has a long history of safe use. It is registered with the EPA for all applications in which it is used. Microbiostatic Antimicrobial Coating provides a durable, invisible micro-biostatic coating to inhibit the growth of germs, bacteria (which cause odor, staining and discoloration) fungi, algae, mold and mildew on common surfaces.

One affordable, easy application will provide long lasting protection. Surfaces protected with Microbiostatic Antimicrobial Coatings are more easily cleaned than untreated surfaces.

Among the benefits that AM500 claims that its product possesses is that it is:(1) EPA

Registered ; (2) Odorless and colorless; (3) Highly durable; (4) Non-toxic; (5) Water based; (6) Provides long term prevention of a wide range of microbial growth; (7) Protects a wide range of surfaces both porous and non-porous; (8) Can be wiped, sprayed or misted on virtually any surface and dries rapidly; (9) Is Non-leaching; and (10) Has no off-gassing.

Turning now to FIG. 1, the cover 10 including its coating 50 and backing member 54 are shown schematically. Preferably, the label stock that is used to create the cover 10 of the present invention is a type of label known as a ‘peel and stick’ label. A peel and stick type label stock typically is created from a peel and stick stock web.

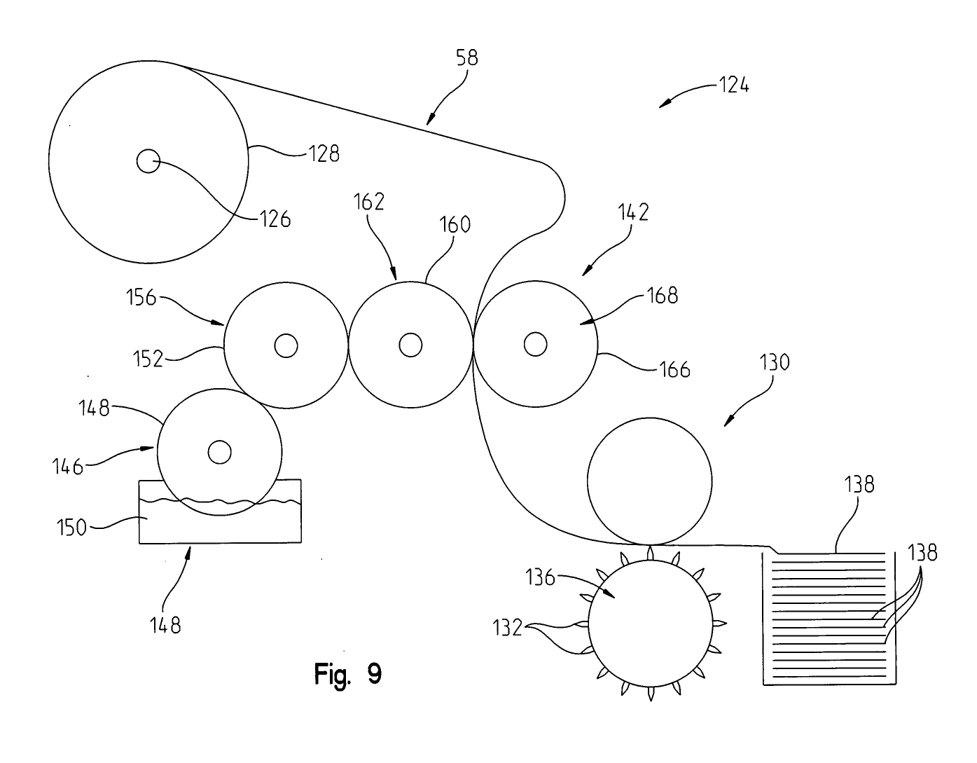

When received by the printer, the stock web 58 (FIG. 9) of label stock usually already includes a backing member that has been joined to the substrate 36. The backing member 50 can be comprised of a variety of materials, but is usually a paper or a plastic material. The lower surface 44 of the cover member 10 base sheet 36 is adhesively joined to the upper surface of the backing member 58. The adhesive 48 layer of the cover member 10 adhesively adheres the base (label substrate) to the backing member 54.

In order to facilitate removal of the substrate 36 member, the adhesive used should have a strength that provides for easy separation between the cover member and the adhesive. In order to facilitate the separation between the substrate 36 and the backing member 54 (known in the industry as release strength), it is very common within the industry to apply a silicone (Si) based coating 60 to the upper surface 62 of the backing member 54. Such a silicone coating 60 gives the paper of the backing member 54 a somewhat “glossy” or “slick” feel, and helps promote the release of the substrate 36 from the backing member 54 separation.

Turning now to FIG. 1A, a plurality of discreet cover members 10, 10b, 10c, 10d and 103 are shown as being disposed on a unitary backing member 54. Each of the cover members 101-10e includes its own substrate 36 as having an antimicrobial coating (e.g. 50a) and adhesive coating (e.g. 48a).

A multi cover member containing device 64 such as is shown in FIG. 1A is preferably made through a die-cutting process wherein a unitary large cover member is formed, that is die cut and separated, such that the cover members 10a, 10b, 10c, 10d and 10e are allowed to remain on the backing member 54, and the scrap cover member material (not shown) between the cover members 10a-10e is removed and discarded.

Turning now to FIGS. 2 and 3, the cover 10 of the present invention is being shown as being applied to an elevator control panel 68. The elevator control panel 68 shown in FIG. 2 includes a plurality of control buttons 14, 16, 18, 20, 22, 24, 26, 28 and 30 with the various buttons 14-30 being used for various functions served by the control panel 68. The greatest number of control buttons 14-30 comprise floor selection buttons 14-24 that permit the user to select the floor to which he desires to travel.

Control buttons exist that are both heat (or touch) activated and spring activated.

Additionally, control buttons may exist for functions such as ‘door open’ 26, ‘door close’ 28 and ‘emergency’ 30.

Typically, the buttons 14-30 are generally disc-shaped. Therefore, a generally disc or “dot”-shaped cover member, such as cover member 72 is formed that coincides in shape, size and area with the contacted buttons 14-30. The cover member 72 is formed, in this instance to have a diameter generally similar to the diameter of the button 14. Because of the transparent nature of the cover member 72, the cover member 72 is preferably applied directly over the button 14. The transparency of the cover member 72 enables the user to see the floor number on the button 14 so that he can select the appropriate floor by pushing the button.

In FIG. 3, a contact actuated button 14 is shown wherein a spring 74 biases the button into a “ready position” from which it can be depressed to activate a contact to inform the elevator control of the floor selection. The button 14 is disposed in an appropriate control panel 76. It will also be appreciated that covers of different sizes and shapes should be provided to accommodate elevator buttons of different sizes and shapes.

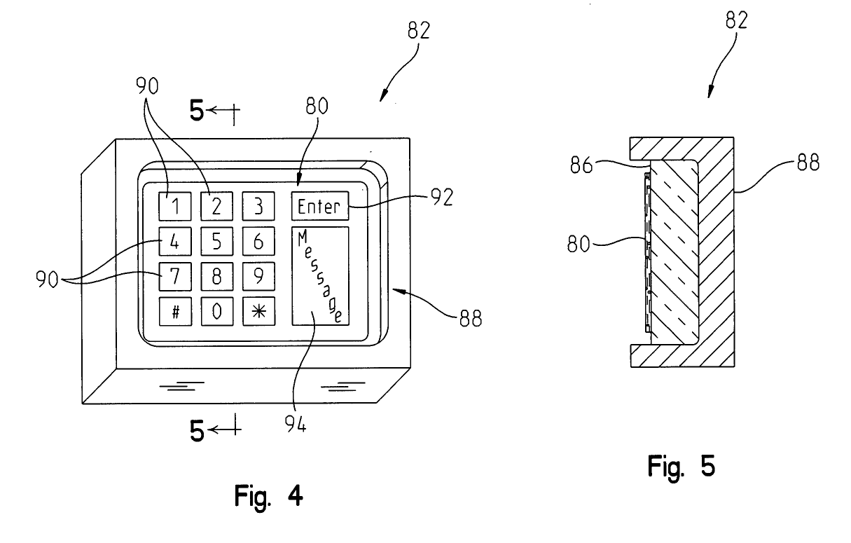

Turning now to FIGS. 4 and 5, a cover member 80 of the present invention is shown as being applied to a touch screen 80. Typically, a touch screen 80 will comprise some sort of display 86, that may comprise a plasma display, CRT display, LCD display or other sort of “television or monitor” type display 86. Most displays 86 have a frame 90 that surrounds the display screen 86 itself. The screen 86 may be one of a large number of sizes, from anything as small as 1 inch by 1 inch, to a larger screen 86 that might be the size of a 42″ television or larger.

Those familiar with touch screen 82 displays 86 recognize that they often have several displayed touch point areas that serve as “buttons” that can be touched to activate a function or do input data. The cover member 80 should have a size that is generally similar to the size of the screen 82 itself By applying the cover 80 to the screen 82, one can see through the transparent cover 80 to the display on the screen 82, to thereby touch the cover 80 at a desired touch point, to impact the screen 82, to thereby make a desired designation or input the appropriate data. In FIGS. 4 and 5, the touch screen is shown as having a plurality of designated touch points, that are configured similar to a calculator of telephone hey pad and includes a plurality of numerals 90, and “ENTER” touch point 92 and a “mesage” ara 94 that may or may not also be a touch point.

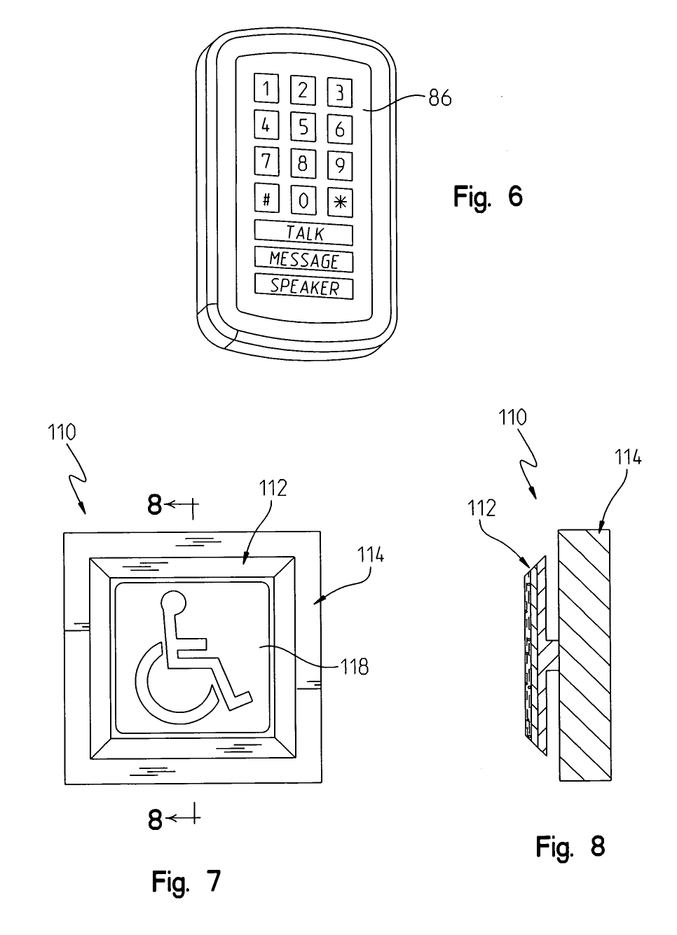

FIG. 6 shows the cover member of the present invention used in connection with a screen cover 98 of the type that one might have on a mobile phone 100. Examples of such touch screen phones 100 include phones such as the iPhone, various Android phones, Windows based phone and even older type Smart Phones, such as the various Treo phones made by Palm. As will be appreciated, such a screen cover 98 could also perform its intended function on a personal digital system or an iPad, iTouch, PDA or other portable table type computer or input display.

Turning now to FIGS. 7 and 8, a handicapped door activator 110 is shown. A handicapped door activator 110 typically comprises a generally rectangular pushable button member 112 that has an area of about 3 inches by 3 inches. The button member 112 itself is spring loaded on to a receiving plate 114. In order to open a handicapped accessible door, one pushes the button 112 that actuates a series of contacts, that activate a motor begin operation to open the door. The cover 118 is attached over the outwardly facing surface of the button 112 handicapped door activator 110, to thereby kill microbes.

The reader's attention is next directed to FIG. 9. FIG. 9 represents a schematic view of a flexographic printing press assembly 124, of the type that is used to apply the antimicrobial agent of the present invention to a cover 10. The first component of the press assembly is a reel 126 that stands (not shown) and that rotatably holds a roll 128 of paper 130. Typically, the stock from which most sheet-like materials are printed comprises either sheet stock or web stock. In the drawings, the paper is shown in its web stock configuration that is spirally wound on to roll 128.

Sheets generally comprise sheets of a certain predetermined size, such as 8½ by 11 inches or 11×17 inches. However, most label printing is done on a web stock. Web stock comprises a roll 128 of the cover member substrate 36 or other material 58 to be printed. Web stock is the most common form of input stock used for printing high volume items. In the drawing, the initial feedstock paper held on roll 128 comprises a partially formed cover member 10, that includes a backing member 54, a silicon release layer coating 60, an adhesive coating 48, and a substrate 36. As it sits on roll 128, the stock does not include an anti-microbial coating.

Typically, the last stage within a printing of a web stock material is a die cut stage 130 where a cutting member such as a die cut plate 132 attached to a roller 136 exists that cuts the web stock, material 58 down into a plurality of discrete sheets of the sizes desired by the purchaser. The die 132 cut can perform “through-cuts” where, for example, it would cut an 11 inch wide web 58 into a plurality of 8.5×11 inch sheets. Alternately, the die 132 can perform a non-through cut, where, for example, only the cover member substrate 36 and coating 50 and adhesive 48 are cut into a plurality of, for example, 1 inch diameter dots, with the base member 54 and silicon layer 60 left intact so that the end user purchase can peel individual dots off of the base member to separate the dots from the base member 54.

A typical printing assembly will include several “printing stations”. Each printing station is usually provided for applying a different print color to the material to be printed. For example, a printing assembly may have six stations to print six different colors. It has been found and is well-known in the printing art, that most colors can be achieved by the application of somewhere between four and six different colors, that, when applied to an item to be printed, blend to form the desired color. For example, printing red over blue will yield purple.

Additionally, one can choose to print an item, such as a brochure, in what is known as one color (which would include just one color of ink applied at just one print station), two-color, three-color or the like. The choice of the numbers of stations to use is based on the number of colors to be applied, which is based on the desire of the users and the budget of the users, as the use of more stations and more colors increases the cost of the printing the particular item. In FIG. 9 a printer assembly 124 having a single printing station 142 is shown for applying the microbibacteriostatic anti microbial coating on to the cover member. It will be appreciated that the coating 50 could well be applied in a multi-station operation where ink was also applied to upper surface 40 of the substrate 36 to print some text or image material thereon.

On a flexographic printing assembly 124 station 142, several rollers are employed at a particular printing station 142. The first roller 146 that is used is a roller known as a metering roller 146. The metering roller 146 is placed above and extends into a tank 148 of solution 150 (usually ink) contained within the solution tank 150. When the metering roller 146 turns, the passage of its surface 148 through the solution 150 within the tank 148 causes the metering roller 146 surface to pick up solution onto the surface 148 . This solution is then deposited onto the surface 152 of a second roller 156 known as an Anilox roller 156. The surface 148 of the metering roller 146 rolls against and in contact with the surface 152 of the second (Anilox) roller 156.

An Anilox roller 156 is a roller that includes a plurality of holes on its surface 152. Often, a printing company will have a plurality of Anilox rollers 156, with each different Anilox roller having holes of a different size. Different hole sizes are used because different hole sizes apply inks at different rates, with a generally smaller holes producing a finer stream of the solution, such as ink or bacteriostatic antimicrobial coating material. The choice of which particular Anilox roller to employ is normally within the scope of the skill of an artisan within printing industry and is determined by the particular item being printed.

The surface 152 of the Anilox roller 156 is placed in opposition the exterior circumferential surface 160 to a plate-containing roller 162. The plate-containing roller 162 includes the printing plate disposed on surface 152 that contains the image of the item to be printed on the area of the cover member 10 to be coated with the anti-microbial coating. The surface 152 of the Anilox roller 156 engages the surface 160 of the plate roller 162 to apply ink or antimicrobial coating material to the printing plate that is contained on the surface 160 of the plate roller 162.

The plate roller 162 engages the actual printing stock 58. Typically, a pressure roller is placed adjacent to the plate roller 160 to maintain the web stock of paper 58 in a pressure relationship to the printing plate and plate roller 160. One or more die 132 cut rollers 136 are disposed down-line from the printing plate roller 160, along with a second pressure plate roller 172.

The flexographic printing assembly 124 discussed above is usually used to apply ink to a feedstock. However, in the present invention, the printing assembly 124 is employed to deposit the above-described bacteriostatic antimicrobial coating 50 to the upper surface 40 of a substrate 36 to form the anti-microbial coated cover member of the present invention. One of the advantages of the present invention is that it permits an anti-microbial coating to be applied to a substrate 36 through the use of conventional equipment of the type that is likely already possessed by most print shops.

Because of the fact that the covers are generally clear, it is envisioned that in most situations, the antimicrobial agent will be the only material that is “printed” onto the upper surface 40 of the cover member 10 substrate. Printing solid colored indicia with ink is generally not desired. However, there are a few applications, such as toilet handle covers, where one might want an opaque printed cover member 10, rather than a clear transparent cover 10. In such cases, one could apply the ink in one station on the press, and the antimicrobial coating on a second or subsequent printing station of the press. In such cases it is preferred that the anti-microbial coating be the outermost coating of a multi-layer coating and ink print layer.

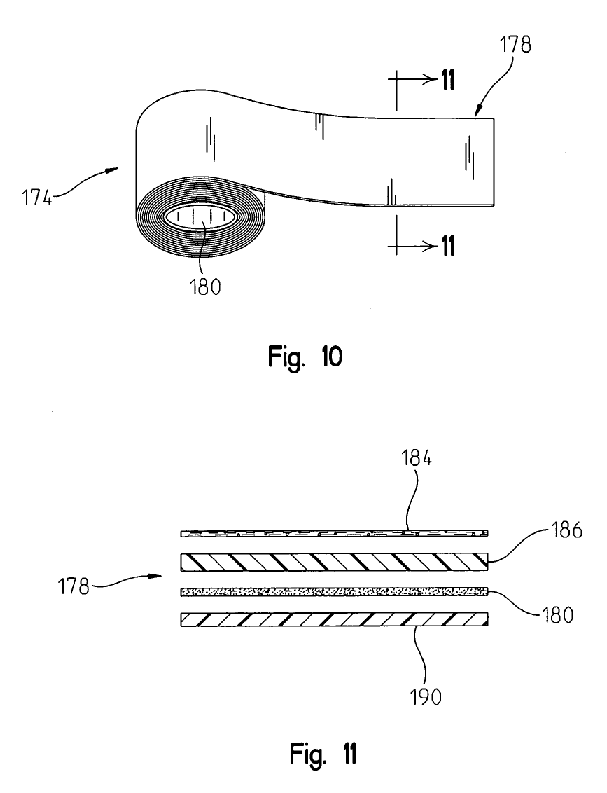

Turning now to FIGS. 10 and 11, a roll of cover material 176 is shown wherein the cover members 176 comprises a long, ribbon or tape like cover member 178. The long or ribbon shaped cover member, just like a roll of tape, can be used to make multiple cover members, each of which is cut to shape by cutting the tape ribbon usually in a direction perpendicular to the main extent of the ribbon and tape member 178. The tape roll member 178 includes a transversely extending holder having a central aperture 180 that is designed for interiorly receiving a spindle (not shown) so that the cable 174 can be placed onto a dispenser that is preferably configured similarly to a tape dispenser.

As shown in FIG. 11, the cover member 178 is generally similar to cover member 10, as it includes a central substrate 186 that is preferably made from a transparent plastic film. An bacteriaostatic antimicrobial coating 184 is applied to the upper surface of the substrate 186 and an adhesive 180 is coated onto the lower surface of the substrate 186. A backing member 190 is releasably coupled to the adhesive layer 180.

The backing member 190 helps to ensure that the antimicrobial layer 184 does not adversely interact with the adhesive layer 180.

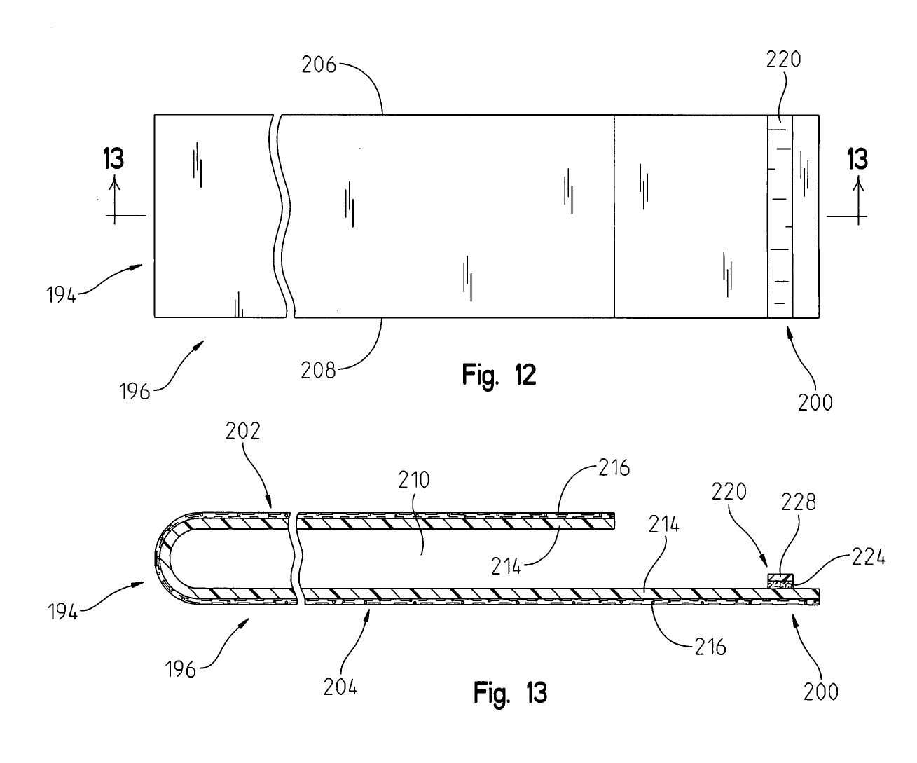

A pouch-like cover member 194 is shown in FIGS. 12 and 13. Pouch-like cover member 194 is especially well adapted for use in interiorly receiving, and covering an object, such as a remote control. One advantage of the pouch-like cover member 194 is that through interiorly receiving not just a surface, but rather the entire received device, the cover member 194 not only helps to stop the spread of germs through its antimicrobial coating, but helps to protect the device from possibly damaging its elements, such as water, grease, spilled liquids and particulate matter.

For example, if a pouch-like cover member 194 was used to encase a keyboard, such as a keyboard used at a restaurant terminal, the cover member would be able to enclose the keyboard (not shown) to thereby lengthen the life of the keyboard by preventing spills, grease and other materials from getting into the keyboard and interfering with the operation of the keyboard.

The pouch-like member 194 is shown as being shaped in FIGS. 12 and 13 for use as a remote control cover member. The pouch-like cover member 194 includes a remote control receiving portion 196 and a flat portion 200. Remote control receiving portion 196 includes an upper shape 202 and a lower sheet 204.

First and second edges 206, 208 extend in a parallel relationship and generally transverse to the closed end 209. The first and second edges 206, 208 are preferably formed by sealing the upper and lower sheet 202, 204 together. When the first and second side edges 206, 208 are joined the pouch-like member includes a closed end 209 that defines a remote receiving interior pocket 210.

The pouch-like member also includes an open end 212 adjacent to the flap that permits the user to insert the remote control into, and remove the remote control from remote receiving interior pocket 210. As is best shown in FIG. 13, the pouch-like member 194 includes a substrate member 214. Substrate member 214 is preferably made from a thin plastic bag film of polypropylene or polyethylene, that may be similar to the material from which food storage bags, such as Zip-lock baggies are made. The substrate member 214 includes an outwardly disposed bacteriostatic antimicrobial coating 216 that extends along the entire outer surface of the pouch 194.

The flap portion 200 is designed to be folded over so that the interior surface of the substrate 214 can be placed against the outer surface 216 of the first or upper sheet 202, to thereby fully encase the remote control contained within the interior pocket 210. To maintain the flap in its closed position, an adhesive member 220 is employed. The adhesive member 220 includes an adhesive 224 that is applied to the interior surface of the substrate member 214. A backing member 228 may be positioned to overlay the applied adhesive 224 to keep the adhesive fresh. Prior to the flap being engaged with the outwardly facing surface 216 of the upper or first sheet member 202, the backing strip 228 is preferably removed to thereby expose the fresh adhesive 224.

In addition to the contacted surfaces and devices described above, the cover member of the present invention has utility on a wide variety of other items. A cover member of the present invention is particularly well suited, include computer screens, mobile communication devices (e.g. mobile phones), screens, computer input devices, such as keyboards and touch screens. Touch screens are found in a wide variety of applications from smaller touch screens that are found on mobile communication devices and personal digital assistance, to larger touch screens that are found at kiosks, at airport check in counters and other customer interactive locations, along with touch screens that might exist at input terminals at various retail and service establishments such as restaurants.

Additionally, the device is particularly well suited for tablet-type computer screens and pad-like computer screens, light switches and light plates and a large number of fixtures that one would find in a house, and especially within a food preparation or personal hygiene facility within an office or commercial structure. Such personal hygiene facilities include such places as bathrooms and kitchens, and include such devices bearing highly contacted surfaces, such as sinks, toilets, commodes, and in particular, flush handles for commodes, urinals, sinks, bathroom hand dryers and the like, along with potentially high contact surfaces such as toilet seats. Additional fixtures within a bathroom or kitchen with which a cover member is particularly well suited include such things as door knobs, door handles, door push plates, door push bars, food preparation and counter top surfaces and the like.

A wide variety of office and retail devices are well suited for the particular device, because it often occurs that a large number of different people are in contact with such devices. Such other commercial devices include keypads that one might find on an ATM, cash register input devices, credit card readers and the like.

The public transportation industry also includes a wide variety of different surfaces that might be served by being covered by a cover member of the present invention. Such things include door handles on cars, taxis and limousines. Large public transportation vehicle surfaces also exist, such as grab rings and grab poles on busses, trains, monorails and the like might be served well by an antimicrobial control surface of the present invention, since a large number of people are always handling such surfaces as they use public transportation. Further, door opening controls, such as the handicapped door opening control button that one finds in many retail, commercial and industrial facilities would also be well served by the present invention.

Having described the invention in detail with references to certain embodiments, it will be appreciated that a variations and modifications can exist within the scope and spirit of the appended claims.

What is claimed:

1. A cover member for attachment to a contacted surface having a predetermined size and shape, the contacted surface being regularly subjected to physical contact, the cover member comprising a sheet-like substrate having a first surface, a second surface and an area sized and shaped to coincide with the predetermined size and shape of the contacted surface, an adhesive layer disposed on the second surface of the substrate, a releasable backing member attached to the adhesive layer, an antimicrobial coating disposed on the first surface.

2. A cover member of claim 1 wherein the antimicrobial coating comprises a bacteriostatic antimicrobial coating, and the substrate comprises a transparent plastic sheet.

3. The cover member of claim 2 further comprising a release layer material disposed between the adhesive layer and the backing member to facilitate separation of the substrate from the backing member.

4. The cover member of claim 3 where the substrate has a tear resistance and the adhesive has a detachment strength matched with respect to each other to form a peelable cover member.

5. The cover member of claim 4 wherein the substrate has a tear resistance and the adhesive has a detachment strength matched with respect to each other to form an ultra-peelable cover member.

6. The cover member of claim 5 wherein the cover member is sized and shaped to fit at least one of a computer screen, mobile communications device screen, computer input device, touch screen, personal digital assistant, tablet computer screen, elevator control surface, light switch, plumbing fixture component, door handle, door knob, door push plate, door push bar, keypad, cash register input device, credit card reader, ATM input device, car door handle, kitchen appliance, public transportation vehicle surface and door opening controls.

7. The cover member of claim 1 wherein the cover member is sized and shaped to fit at least one of a computer screen, mobile communications device screen, computer input device, touch screen, personal digital assistant, tablet computer screen, elevator control surface, light switch, plumbing fixture component, door handle, door knob, door push plate, door push bar, keypad, cash register input device, credit card reader, ATM input device, car door handle, kitchen appliance, public transportation vehicle surface and door opening control.

8. The cover member of claim 1 wherein the antimicrobial coating comprises a bacteriostatic antimicrobial coating that exerts its antimicrobial activity by piercing cell walls of microbes.

9. The cover member of claim 1 further comprising a silicon based release layer disposed between the backing member and the adhesive layer to facilitate separation of the substrate from the backing member.

10. The cover member of claim 1 wherein the substrate has a tear resistance and the adhesive has a detachment strength matched with respect to each other to form a peelable cover member.

11. The cover member of claim 1 wherein the substrate has a tear resistance, and the adhesive has a detachment strength with respect to each other to form an ultra peelable cover member.

12. The cover member of claim 1 where the cover member has a ribbon like configuration, wherein the cover member is spirally wound into a roll configuration, the cover member being dividable into a plurality of cover members having an area, size and shape that coincides with the predetermined size and shape of the contacted surface.

13. A pouch for covering and encasing an electronic device, the pouch comprising a first sheet portion and a second sheet portion coupled to the first sheet portion, for defining a pouch having a hollow interior pocket for receiving the electronic device and an exterior, the hollow interior pocket being defined by a closed end and having an open end through which the electronic device can be inserted into and removed from the hollow interior space, a flap portion disposed and adjacent to the open end and sized configured and positioned for being movable between a first position wherein the open end of the pocket is accessible, and a second position wherein the open end of the pocket is covered by the flap portion, and a bacteriostatic antimicrobial coating disposed on the exterior for killing microbes on the exterior by piercing all walls of the microbes.

14. The pouch of claim 13, further comprising an adhesive applied to a surface of the flap portion, the adhesive being positioned for adhesively attaching the flap portion to the exterior of the pouch for maintaining the flap in the second position.

15. A process for forming a cover member having antimicrobial properties comprising providing web of substrate, providing a tank for holding an antimicrobial solution, providing antimicrobial solutions contained within the tank, the antimicrobial solution comprising a bacteriostatic antimicrobial solution capable of killing microbes by piercing cell walls of microbes, providing a pick up roller positioned to have an exterior capable of passing through the antimicrobial solution, providing an Anilox roller, passing the pick up roller through the antimicrobial solution to deposit antimicrobial solution on to the pickup roller, engaging the pick up roller with the Anilox roller to transfer the antimicrobial solution from the pick up roller to the Anilox roller, engaging the Aniluox roller with a surface of the web substrate for depositing a layer of antimicrobial solution on the surface of the web substrate, and providing a cutting die and using the cutting die to cut the member into a size and shape to coincide with a contacted surface or device.
